(19) United States
(12) Patent Application Publication
(10) Pub. No.: US 2006/0155553 A1
(43) Pub. Date: Jul. 13, 2006

(54) Risk management methods and systems

(76) Inventors: Carole Gloria Brohman, Westmount (CA); Robert Lance Bexon, Westmount (CA)

Correspondence Address: SMART & BIGGAR;P.O. BOX 2999, STATION D, 900-55 METCALFE STREET, OTTAWA, ON, K1P5Y6, CA

(21) Appl. No.: 11/024,696

(22) Filed: Dec. 30, 2004

(51) Int. Cl. G06Q 99/00; G05B 19/418; G06F 9/46

(52) U.S. Cl. 705/1; 705/8

(57) ABSTRACT

Risk management methods and systems are disclosed. Information regarding implicit social contracts affecting an organization is collected from one or more sources which are external to the organization. A reputation risk to the organization is then identified based on the collected information, and an indication of the identified reputation risk is provided to the organization. If multiple reputation risks are identified, then the risks may be ranked according to one or more ranking priority criteria. Once identified, reputation risks may be used, for example, in determining a valuation associated with the organization, implementing a remedial action plan for the organization to mitigate the reputation risks, and implementing a training program to disseminate the implicit social contracts, the reputation risks, or both. Reviews of activities of other organizations or legal proceedings relating to the implicit social contracts or any identified risks may be useful in assessing the magnitude of a risk.

### FIELD OF THE INVENTION

This invention relates generally to risk management and, in particular, to methods and systems of managing reputation risks of an organization.

### BACKGROUND

Risk management is a growing preoccupation in many business organizations. Current risk management techniques generally entail asking employees and occasionally other internal stakeholders within an organization to list and rank perceived risks, and also to define actions which are necessary to reduce or eliminate the risks. These risks can be classified into areas such as industry trends and environmental issues, technology threats, business recovery plans, product tampering, etc. Typically, these risks also tend to be heavily operational in nature and are relatively transparent to an organization. The processes used to identify risks to a company and ensure that they are mitigated are internal.

The above conventional approach to risk management may be effective and important for operational risks, but might not work as well for other types of risk such as reputation risks. Reputation risks may, for example, be associated with actual or potential behaviour of an organization in a manner which crosses some moral or ethical boundary or could be interpreted as having betrayed a public trust. The latter type of reputation risk might involve an organization not taking an action which the general public trusts that it would take, or conversely taking an action which the general public trusts that the organization would not take. These trusts, and more generally reputation risks, may of course be different for different organizations.

Reputation risks and/or any trusts from which they arise are often implicit within certain market segments or business activities and accordingly may be more difficult to isolate than operational risks. Further complicating the issue of reputation risk is the fact that activities which have the potential to damage an organization's reputation are often viewed, at least internally, as normal and necessary to the business activities of the organization. Therefore, it may be particularly difficult for internal personnel to identify reputation risks.

Knowledge of the trusts that a public invests in an organization is valuable in that it allows an organization to assess the riskiness of its activities. Conventional risk management techniques do not identify trust themes through social research to provide a basis for assessment of risks, which are an organization's activities that may resonate against these themes. Similar to financial auditors, who bring external objective verification to financial assurance, internal generation of the themes in accordance with conventional techniques is insufficient for identifying and managing reputation risk.

Without an effective technique for identifying the social trust themes, an organization cannot accurately determine the extent to which its activities are synchronous with expectations, the degree to which its competitors, regulators, or other “adversaries” are focusing on resonant themes, or the extent to which seemingly unrelated legal proceedings such as jurisprudence on those themes in other industries is in fact a threat to the organization. These challenges may also result in difficulties in training an organization's staff to avoid behaviours that may inadvertently jeopardize the organization's reputation.

The importance of reputation risk management is further illustrated by considering the fact that in the United States, for example, according to a report entitled “Measuring And Valuing Brand Equity” which was prepared by Brand Finance in collaboration with the Institute of Communications and Advertising and published in 2004, only about 20% of S&P 500 companies' market capitalization tends to be represented by current assets, and that the companies' reputations underpin at least a portion of the balance. By comparison, in about 1980, current assets were approximately 75% of companies' market capitalization. Reputation risk management is therefore emerging as a new and important aspect of overall organization management.

### SUMMARY OF THE INVENTION

In view of the foregoing, there remains a need for improved reputation risk management techniques. There remains a particular need for reputation risk management techniques which identify social trusts, expectations, or risk factors, generally referred to hereinafter primarily as “implicit social contracts”, which affect an organization based on information which is collected from sources external to an organization.

According to one aspect of the invention, there is provided a risk management method which includes operations of collecting, from at least one source external to an organization, information regarding implicit social contracts affecting the organization, identifying a reputation risk to the organization based on the collected information, and providing to the organization an indication of the identified reputation risk.

The operation of collecting may involve collecting the information using at least one of: social survey, public document review, and retrieving previously collected information. The information may also be collected from multiple sources.

Any activity of the organization which may breach or fail to fulfil any of the implicit social contracts may be identified as a reputation risk.

The indication of an identified risk may be provided in any of many forms, such as a printed indication, a displayed indication, an indication which is stored for subsequent retrieval, and an indication which is electronically transmitted to the organization.

In some embodiments, multiple reputation risks are identified. In this case, the method may include the further operation of ranking the identified reputation risks according to at least one ranking priority criterion. The operation of providing may then involve providing an indication of the identified reputation risks in order of ranking. Ranking priority criteria may include, for example, a frequency of occurrence criterion associated with a frequency of occurrence of each of the implicit social contracts in the collected information, a source rank criterion associated with rankings of the at least one source, and a source-assigned priority criterion associated with implicit social contract priorities assigned by the at least one source.

Other operations which may be performed in accordance with embodiments of the invention include determining a valuation associated with the organization using the identified reputation risk, determining and implementing a remedial action for the organization to mitigate the identified reputation risk, collecting further information regarding risk factors affecting the organization from at least one internal source within the organization, and determining and implementing a training program for the organization to disseminate the implicit social contracts, the identified reputation risk, or both.

An environmental review may also be conducted for an organization by collecting further information associated with activities of at least one other organization relating to the implicit social contracts or any identified risks and providing an indication thereof to the organization.

In some embodiments, a review of legal proceedings relating to the implicit social contracts or any identified risks is performed, and an indication thereof is provided to the organization.

The information collection may be repeated, using the same or different information sources, to determine a change in current collected information and previously collected information and a risk vector for the reputation risk based on the determined change.

A risk management system is also provided, and includes an information collection module for collecting, from at least one source external to an organization, information regarding implicit social contracts affecting the organization, a risk management module coupled to receive the collected information from the information collection module and configured to identify a reputation risk to the organization based on the collected information, and an output for providing to the organization an indication of the identified reputation risk.

The risk management system may also perform further functions, such as those described above.

A risk management method according to yet another aspect of the invention includes operations of collecting, from at least one source external to an organization, information regarding implicit social contracts affecting the organization, identifying a reputation risk to the organization based on the collected information, collecting further information associated with activities of at least one other organization relating to the implicit social contracts or the identified risk, and providing to the organization an indication of the identified risk and the activities of the at least one other organization.

Other aspects and features of embodiments of the present invention will become apparent to those ordinarily skilled in the art upon review of the following description of specific illustrative embodiments of the invention.

### BRIEF DESCRIPTION OF THE DRAWINGS

Examples of embodiments of the invention will now be described in greater detail with reference to the accompanying drawings, in which:

FIG. 1 is a flow diagram of a method according to an embodiment of the invention;

FIG. 2 is a block diagram of a system in accordance with an embodiment of the invention; and

FIG. 3 is a block diagram of an exemplary system in which embodiments of the invention may be implemented.

### DETAILED DESCRIPTION OF PREFERRED EMBODIMENTS

As discussed above, reputation risk assessment and management present significant challenges for conventional risk management techniques. Reputation risk involves external risk factors, referred to herein as “implicit social contracts”, which would not typically be identifiable through conventional internal surveys and analyses conducted by an organization.

Consider an example of product marketing. Surveying the purchasing or consumption behaviours of a specific segment of population, a particular age group for example, and then establishing media targets which address that population segment would generally be considered a normal business activity. Conventional risk management methodologies within an organization would not isolate this activity as involving a risk. However, it may well be that there is an implicit social contract in that the general public, or important segments thereof, may expect organizations not to market certain products to certain segments of the population, to youth or the elderly for instance. In the event that such activities come to the attention of the general public, the resultant public reaction may have severe consequences for an organization, including in some cases the establishment of new regulatory requirements and initiation of litigation, each of which may incur very substantial costs to an organization or substantially diminish its value.

The lack of effective reputation risk management techniques has become even more apparent from relatively recent developments in the financial accounting industry. Virtually all major accounting firms have now split their consulting and auditing practices, primarily as a result of a high-profile scandal in which reputation risks were not properly identified. When the public became aware of questionable accounting methods which were used by an audit branch of an accounting firm which also performed substantial consulting work for a client of its audit branch, the objectivity and impartiality of the audit branch was called into question. In hindsight, it was clear that the accounting firm had failed to fulfil an implicit social contract of impartial, honest, and objective auditing of financial reports. This failure highlights one of the primary shortcomings of traditional risk management, in that the implicit social contract, which was based on a widely held public expectation and had such a significant impact on not only the accounting firm involved but also other accounting firms, was not properly identified. Using the techniques disclosed herein, this implicit social contract could have been identified and appropriately addressed.

In accordance with an embodiment of the invention, effective reputation risk management would begin by identifying and scaling these reputation risks and implicit trusts in the social setting. By gathering information through social research, for example, implicit social contracts, illustratively social trusts and/or other risk factors that are vested on an organization, are identified and preferably ranked. An organization's activities may then be considered in the context of these implicit social contracts, to identify as risks any activities which potentially risk breaching or not fulfilling one or more of the implicit social contracts. Based on the implicit social contracts, practices and policies of an organization may be reviewed for coherence, and possibly to formulate remedial actions to be taken by the organization.

Further information collection or social research, from the same or different sources, may be performed to assess the potential impact of any breach or failure to fulfil an identified implicit social contract, or possible remedial actions intended to mitigate identified risks.

Additional risk-based assessments may also be undertaken, including reviews of an organization's external environment to determine the degree to which hostile Non-Governmental Organizations (NGOs), regulators, competitors in a market segment or industry, and/or other entities have identified and are acting on the identified implicit social contracts and/or risks, and reviews of litigation, legislation, and other legal proceedings or activities in other industries that may have pertinence to the same or similar reputation risk issues, for instance.

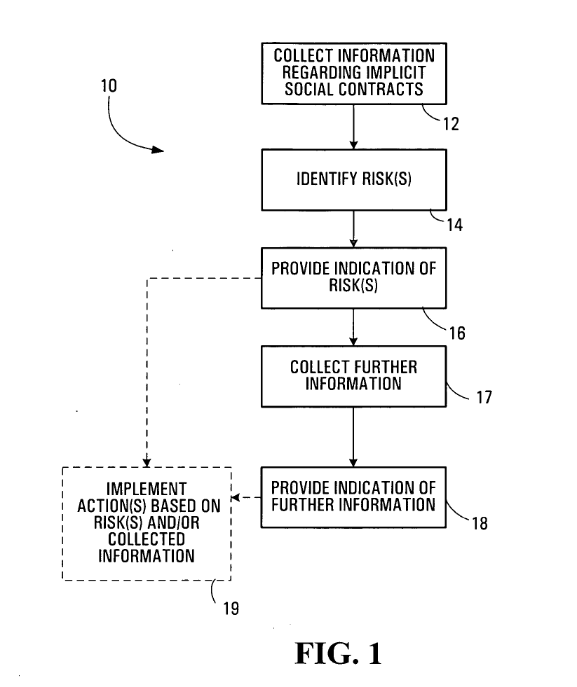

These and other features of embodiments of the invention are described in further detail below, with reference first to FIG. 1, which is a flow diagram of a method according to an embodiment of the invention. It should be appreciated that embodiments of the invention may include further, fewer, or different steps which may be performed in a different order than explicitly shown in FIG. 1. Therefore, FIG. 1, as well as the contents of the other drawings, are intended solely for illustrative purposes. The invention is in no way limited to the particular embodiments shown in the drawings and described herein.

The risk management method 10 of FIG. 1 begins at 12, with an operation of collecting information from one or more sources which are external to an organization. The information collected at 12 relates to implicit social contracts which may affect the organization.

The operation of collecting information at 12 may involve, for example, collecting information through social surveys. Surveying consumers and possibly other stakeholders associated with a particular market segment or industry in which the organization is involved allows surveyed stakeholders, or more generally the organization's market, to express key risk factors. It should be appreciated that different organizations may have different “publics” from which information is collected at 12. For a manufacturer of consumer products for instance, any or all of consumers, distributors, and suppliers may be publics of interest. For an accounting firm, a public of interest might be publicly traded companies, whereas a public of interest for a mutual fund company could be market investors. Other organizations or types of organization may have further possible publics of interest.

Recording and tracking of social survey results may also facilitate benchmarking between organizations, within an industry or market, or between different industries or markets. Organizations may thereby be provided with baselines for systematically and regularly evaluating their performance in managing identified risks, relative to their own past survey results or those of other organizations.

External information may also or instead be collected at 12 through reviews of public documents originating with other organizations or industry regulators for instance. Other possible techniques for collecting risk factor information may be apparent to those of skill in the art to which the present application pertains.

The method 10 proceeds at 14 with identifying one or more reputation risks to the organization based on the collected information. This may involve, for example, analysis of responses to questionnaires which have been designed to solicit input from an organization's public(s) in regard to general or particular implicit social contracts and administered to the public(s) in a statistically valid fashion. The identification of risk(s) could then be performed by matching an organization's activities or practices against the implicit social contracts which are identified based on the information collected at 12.

The operations performed at 14 may involve some analysis of both collected information and an organization's activities and practices. The extent to which the collected information is analyzed may depend, for example, upon the level of detail of the collected information.

As mentioned above, a questionnaire through which information is collected at 12 may solicit input in regard to general or particular implicit social contracts. For example, a questionnaire may ask those surveyed to rank very general risk themes, such as issues affecting youth or health. Although social surveys may indicate that both of these risks themes are important, further analysis of the survey results may be performed at 14 to identify more particular implicit social contracts for different organizations. For a financial institution, an implicit social contract might be that youth should be targeted for education on effective financial planning. Based on the same general risk theme, a different implicit social contract may be identified for a different organization. The public may trust that a manufacturer or vendor of alcohol products will not specifically target a youth market with advertizing, for instance.

In other embodiments, a survey questionnaire is more specific to an organization or industry, and solicits input on particular potential implicit social contracts. The analysis of collected information at 14 in this case may be less substantial, in that potential implicit social contracts have already been identified, and can be used as a basis for identifying risks.

Therefore, it should be appreciated that operations at 14 may involve different levels of analysis of the information which is collected at 12.

Turning now to the identification of risks based on implicit social contracts, one embodiment of the invention involves considering three factors in the information processing of collected information, including the size of the group which holds an expectation from which the implicit social contract arises, the importance of the expectation to that group, and the degree to which that group believes an organization to be compliant with their expectations. A widely held expectation which has been assigned a low importance and with which an organization is thought to be compliant will present a significantly different risk profile than an important conviction held by a narrowly defined group which believes an organization is not in compliance. The collected information is analyzed to make these definitions, which may also be used as a basis for ranking and prioritization of risks as discussed in further detail below.

Once the implicit social contracts have been identified and analyzed, an organization's activities and practices are considered in the context of the implicit social contracts to identify any activities or practices which would be related to these implicit social contracts. The activities and practices may include existing and/or planned activities and practices. For convenience, activities, practices, and any combinations thereof, are referred to hereinafter primarily as activities. Relevant activities may be identified through internal surveys such as management interviews or from other information sources which are internal to the organization. Activities which may breach or fail to fulfil an identified implicit social contract represent reputation risks.

After a risk has been identified at 14, the method 10 continues at 16, with providing to the organization an indication of the identified reputation risk or risks. Providing the indication may involve printing an indication of any identified reputation risks, to provide a printed risk report to the organization, for example. Where the organization itself manages the method 10, the indication may be presented on a computer system display. Another option for providing the indication involves storing data in a memory. The stored data may then be subsequently retrieved to provide an indication of the identified reputation risk or risks, such as in a printed or displayed risk report. Data representing the indication or data from which the indication can be generated may also or instead be transmitted the organization.

The indication provided at 16 need not necessarily be restricted only to identified risks. For example, it may be useful to include an indication of the collected information along with an indication of identified risks. This would allow the organization to consider not only any identified risks, but also the implicit social contracts based upon which the risks were identified. A detailed description of each risk in the indication, i.e., the particular activities which are pertinent to each implicit social contract, may also be desirable.

When more than one risk is identified at 14, the risks may be ranked, so as to provide the organization with an ordered or prioritized list of identified risks. Ranking may be performed by applying one or more ranking priority criteria to the collected information, the identified risks, or both. The indication provided at 16 may then include an indication of both the identified risks and any ranking priority criteria which were used to rank the risks.

Ranking priority criteria may include, for example, a frequency of occurrence criterion associated with a frequency of occurrence of each of the implicit social contracts in the collected information. According to one such criterion, risks associated with respective implicit social contracts are ranked in decreasing order of the number of times the implicit social contracts, or general risk themes from which the implicit social contracts were identified as described above, were specified in the collected information. In some embodiments, different sources from which information is collected may have respective priorities. Identified risks may then be ranked according to the priority of a source from which an implicit social contract associated with an identified risk was collected. Priorities assigned to implicit social contracts by information sources, where sources are asked to prioritize the implicit social contracts for instance, may also or instead be considered when ranking identified risks. It should be apparent that other ranking priority criteria may be used to rank identified risks, and that ranking may be based on multiple criteria.

The above example priority ranking criteria relate to implicit social contracts and ranking of risks based on priorities of the implicit social contracts from which they arise. Although collected information may outline how important a particular implicit social contract is, determining the priority of risks may involve further evaluation. Consider a situation in which survey results indicate that product integrity has been rated 7 on a scale of 10 and media targeting has been rated 10 on a scale of 10, but a review of an organization's environment indicates that a well funded and highly connected advocacy network is focused on product integrity issues in an organization. Whereas a ranking based only on survey results would rank media targeting above product integrity, a ranking which involves further analysis may reverse this rank based on the identification of the advocacy network.

In some embodiments, one or more action plans are implemented and/or actions are taken at 19 based on any identified risks, the collected information, or both. An example of an action which might be taken at 19 is the determination of a financial value associated with each identified risk. Risk values may then be used in determining a valuation of the organization, for instance. A valuation may be used for such purposes as setting a share price or acquisition price for the organization.

The value associated with an identified risk may represent a combination of the reward associated with an activity which has been identified as a risk and the actual value which could potentially be destroyed or not realized if the risk were avoided. Another possible basis for evaluating a risk is to consider the negative impact of a risk which could be perceived as breaching or not fulfilling an implicit social contract. As noted above, reputation may represent a significant portion of an organization's market capitalization, and accordingly market capitalization may be used in some embodiments to arrive at an estimate of risk value.

Risk evaluation techniques may also take into account the social survey factors described above, namely the size of the group which holds an expectation from which the implicit social contract arises, the importance of the expectation to that group, and the degree to which that group believes an organization to be compliant with their expectations. Other factors may also be considered.

When risk values have been determined, their potential impact on a share price or a valuation of an organization may also be determined. Risk values themselves may also be of interest to an organization, and may be included in a risk indication which is provided to the organization. For example, the indication provided at 16 could include an indication of each identified risk, along with respective vectors representing the value of the risk and the priority or “degree” of the risk.

Other operations which could be performed at 19 include determining and implementing a remedial action plan for the organization to mitigate any identified reputation risks. Based on any identified risks, the organization might decide to undertake, or alternatively to avoid, certain activities, such as marketing a particular product to a specific segment of consumers.

Training represents another possible action which may be implemented at 19. Key implicit social contracts and examples of risk activities may be disseminated throughout an organization. When employees are made aware of these implicit social contracts and risks, the organization may be able to more effectively manage reputation risk by avoiding inadvertent risk behaviours which would not have previously been recognized as potentially impacting the organization's reputation.

The present invention preferably does not preclude the use of additional risk management techniques, including conventional operational risk management techniques for instance. Thus, the method 10 may proceed at 17 with collecting further information, such as information from one or more internal sources within the organization regarding risk factors affecting the organization. The internal sources from which the further information is collected may include internal company documents and employee surveys or interviews. In some embodiments, either or both of the information collected at 12 and the risks identified at 14 are analyzed so as to target particular sources or types of further information to be collected. Internal information may be used to identify operational risks to the organization, in addition to the reputation risks identified at 14. At 18, an indication of the further information collected at 17, and possibly risks or other results of processing the further information, is provided to the organization.

The further information collected at 17 need not be limited to or even include internal information. For example, information associated with activities of other organizations may be of use in assessing and managing risk. Other organizations in the same market or industry may also be involved in activities relating to the implicit social contracts or risks identified for an organization. An indication of these activities may provide insights into whether the same or similar risks have been identified or actions are being taken on the basis thereof by other organizations. An indication of any of the activities, associated implicit social contracts or risks, and the potential impact of the activities on the organization may be provided at 18.

This type of review of an organization's external environment may involve identifying other organizations which may be a threat to the organization. For example, other organizations which possess a relatively high degree of knowledge of the implicit social contracts or have accurately identified risks associated with the implicit social contracts may have thus targeted aspects of the organization which may be particularly vulnerable. Information regarding such organizations and their activities may be valuable for an organization's overall risk management plan.

Another example of the further information which may be collected at 17 is information associated with legal proceedings relating to the implicit social contracts or the identified risks. Legal proceedings may include not only litigation, but also regulatory activities and legislative activities, for example. These legal proceedings may include proceedings in which the organization is or is not directly involved. For example, the British Columbia Tobacco Recovery Act has been introduced in the province of British Columbia, Canada. If upheld, the Act could make it possible for governments to sue not only tobacco companies, but also any other organization whose products statistically impact health, to recover the costs they are judged to have created in the health care system.

At.18, indications of the legal proceedings and the potential impact thereof may be provided.

In some embodiments, actions are determined and implemented at 19 on the basis of the further information or results of any processing thereof. Examples of such actions have been described above. For instance, a remedial action plan may be developed or revised based on further public surveys. The degree to which a proposed action plan would be perceived as not breaching, or alternatively as fulfilling, an implicit social contract may thereby be determined before the action plan is implemented. In assessing a proposed action plan, the information may be collected from the same sources from which information was initially collected at 12 or from different sources. A proposed action plan may affect both consumers and distributors of a product, for example.

Although the operation of identifying risks at 14 is shown in FIG. 1 as preceding the collection of further information at 17, it should be appreciated that risk identification may be based on both external information collected at 12 and further information collected at 17.

As those skilled in the art will appreciate, risk management may be an ongoing process. Reputation risks are preferably re-evaluated periodically by effectively repeating the operations at 12, 14, and 16. A change in current collected information and previously collected information may be indicative of a change in public sentiment toward an organization, perception of an organization, or other risk factors. Based on such changes, risk vectors for any identified risks may be determined. Indications of any changes or risk vectors may then be provided substantially as described above.

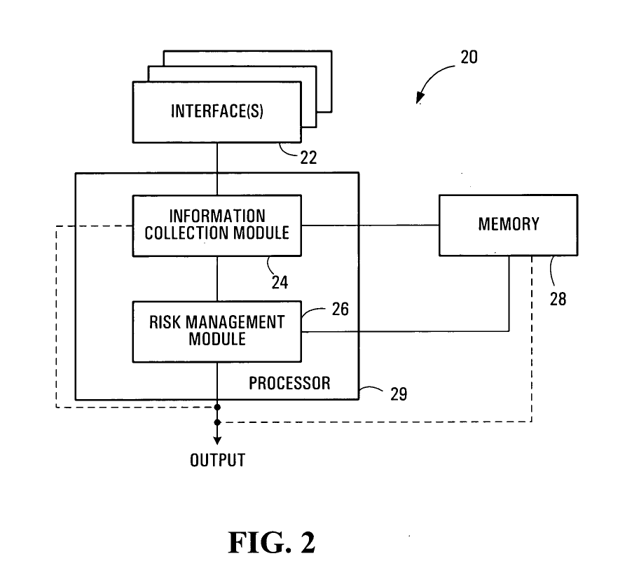

FIG. 2 is a block diagram of a system in accordance with an embodiment of the invention. The system 20 of FIG. 2 includes an information collection module 24 coupled to one or more interfaces 22, a risk management module 26, and a memory 28. The risk management module 26 is also coupled to the memory 28 and provides at an output an indication of identified risks, collected information, or other information as described in further detail herein. In some embodiments, the information collection module 24, the risk management module 26, or both, are implemented in a processor 29. The system 20 may be incorporated into or implemented conjunction with a larger system such as a computer system, which may include further components in addition to those shown in FIG. 2. Thus, the present invention is in no way limited to the particular system as shown in FIG. 2, and may be implemented using further, fewer, or different components which may be interconnected in a different manner.

Each interface 22 represents a component or device through which information may be collected by the information collection module 24. Examples of such devices include a user input device and a transceiver, as described in further detail below.

The information collection module 24 may be implemented using a hardware component such as an Application Specific Integrated Circuit (ASIC) or in software stored in the memory 28 for execution by a processor 29. A microprocessor and a microcontroller are illustrative examples of processors which may be used as the processor 29, although other types of processing components suitable for use as the processor 29 may be apparent to those skilled in the art.

The risk management module 26 may similarly be implemented in hardware or software.

Any of many different types of memory device may be used to implement the memory 28, including solid state memory devices, disk drives, or other types of memory device associated with fixed, movable, or even removable memory media. Although shown as a single block in FIG. 2, the memory 28 may include multiple memory devices of the same type or different types.

In operation, the information collection module 24 collects, from at least one source external to an organization, information regarding reputation implicit social contracts affecting the organization. This information may be stored in the memory 28 or passed to the risk management module 26. In some embodiments, the information collection module 24 collects the information from previously collected information which has already been stored in the memory 28 or another local or remote memory (not shown).

The information collection module 24 may also perform such functions as parsing information which is collected through surveys or questionnaires. For example, the information collection module 24 may be configured to send electronic surveys or forms to consumers for completion, and to receive completed surveys or forms. Information in the completed surveys or forms may then be parsed or otherwise processed to extract implicit social contracts, priorities, demographic information, and possibly other information to be used for the purposes of risk management.

The risk management module 26 receives the collected information from the information collection module 24 directly, or possibly indirectly by accessing the memory 28, for example, and is configured to identify a reputation risk to the organization based on the collected information. In a processor-based embodiment as shown in FIG. 2, it should be apparent that the processor 29, and thus the modules 24 and 26, may be configured to perform the various functions disclosed herein by executing software stored in the memory 28.

Various techniques for processing collected information and identifying risks are described in detail herein. Implementation of these techniques in the modules 24 and 26, whether in hardware, software, or some combination thereof, will be apparent to those skilled in the art of electronic information processing in view of the detailed disclosure of such techniques provided in the present application.

An indication of the identified reputation risk is provided to the organization at the output of the risk management module 26. As described above, the indication may be provided as a printed indication, on a display (not shown), in a communication signal which is transmitted to the organization, or stored in the memory 28.

Further functions of the information collection module 24 and the risk management module 26 will be apparent from the foregoing description. The risk management module 26 may be configured to identify and rank multiple reputation risks for instance. The output indication may also include the collected information, as represented by the dashed line connecting the information collection module 24 and the output of the risk management module 26, and/or any ranking priority criteria used to rank identified risks. Further information collection and processing as described above may also be supported by the system 20.

The output of the risk management module 26 may be further processed or used by other components of the system 20. In the case where reputation risk functions are provided by a service provider or other entity which is external to an organization for instance, such further processing may be performed by other systems implemented within the organization.

In one embodiment, a risk indication is provided to a valuation system for determining a valuation associated with the organization using the identified reputation risk. The risk management system 20 or another system may also or instead determine a remedial action plan for implementation by the organization to mitigate the potential effects of any identified reputation risks.

Other operations, including collection and processing of further information, identification of operational risks, determination of potential impacts of an organization's activities and/or legal proceedings on the organization, and monitoring for changes in collected information and determination of associated risk vectors may be supported by the system 20 or one or more other systems which receive outputs from the system 20.

It should therefore be appreciated that the system 20 may operate in conjunction with other systems which participate in an overall risk assessment and management program for an organization. Whereas reputation risks might be identified by a service provider which is external to an organization, findings of the service provider may be used in conjunction with the organization's own internal operation risk management programs. Different aspects of reputation risk management, such as external information collection, further information collection and processing, impact assessments for activities and/or legal proceedings, and change monitoring, may similarly be performed by different entities.

Thus, embodiments of the invention may involve incorporation of all risk management functions into a single system or service to provide comprehensive risk management for an organization, the provision of only reputation risk management functions, or an intermediate approach in which reputation risk management functions are combined with some other risk management functions.

Different product or service offerings associated with embodiments of the invention are also contemplated. Reputation risk management, whether on its own or in combination with other risk management functions, may be provided as an external service, under contract for instance, to one or more organizations. An organization may instead prefer to licence a reputation risk management technique, and/or a system for implementation thereof, for use internally within the organization.

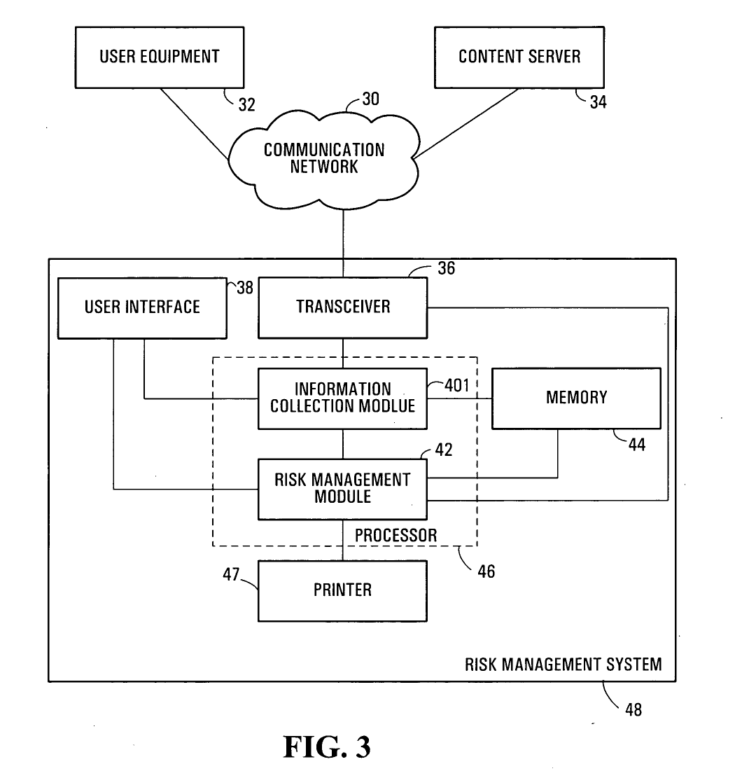

Methods and systems in accordance with embodiments of the invention have been described in detail above. FIG. 3 is a block diagram of an exemplary system in which embodiments of the invention may be implemented.

The system of FIG. 3 includes a risk management system 48, which is substantially similar to the system 20 of FIG. 2. The information collection module 40, the risk management module 42, the processor 46, and the memory 44 may be the same as the similarly labelled components shown in FIG. 2 and described above.

The user interface 38 and the transceiver 36 represent examples of the interface(s) 22 of FIG. 2. The user interface 38 may include such input devices as a keyboard and a mouse which may be used in conjunction with a display for entering information into the risk management system 48. For example, an operator or administrator of the risk management system 48 may manually enter survey results collected from external sources via a user interface 38 provided by one or more input/output devices.

Other user functions may also be supported by the user interface 38, including system administration or other control or configuration functions. Indications of identified risks may also be provided through the user interface 38, possibly using output devices which are also used for information collection or system control and configuration functions. For example, a display which is used to present data entry screens to a user during information collection may also be used to display system administration screens and an indication of any identified risks.

The transceiver 36 enables the information collection module 40 to collect information from remote sources. Through the transceiver 36 and the communication network 30, illustratively the Internet, the information collection module 40 may send an electronic form or survey which has been stored in the memory 44 to the user equipment 32 for completion by a user. Although only one piece of user equipment 32 is shown in FIG. 3, it should be appreciated that the information collection module 40 may communicate with many users to collect information.

Many different types of the transceiver 36 and the communication network 30 will be apparent to those skilled in the art. The Internet has a particularly extensive reach and may thus be especially useful for information collection from remote users and other sources. However, other types of communication network may also or instead be used for communication between the risk management system 48 and any information sources to be consulted or accessed. The structure and function of various types of transceivers and communication networks are well understood and thus have not been described in detail herein. In general, the transceiver 36 performs such functions as modulation/demodulation and protocol conversion to allow information to be transmitted and received through the communication network 30.

It will also be well understood that the user equipment 32, as well as the content server 34 described in further detail below, would include a transceiver which is compatible with the communication network 30. This does not mean that the various components which communicate through the communication network 30 must include the same type of transceiver. Often, a communication link between communication equipment includes different types of media or connections. For example, the user equipment 32 may be connected to the communication network 30 through a wireless communication path and would then include a wireless transceiver. In this case, the transceiver 36 may be a wired modem through which the risk management system 48 communicates with the communication network 30. Other combinations of different types of transceiver which enable end-to-end communications between the risk management system 48 and other communication equipment are also contemplated.

The transceiver 36 additionally provides for communication with a content server 34. The content server 34 represents a further source of information. In addition to a transceiver which is compatible with the communication network 30, a content server 34 generally includes a data store for storing electronic content and a processing system which handles requests for the stored electronic content. The information collection module 40 may thereby request and receive information from the content server 34. This information may include, for example, previously collected information, previously generated risk indications, published documents, legislation, etc., or any combinations thereof.

Like the user interface 38, the transceiver 36 may be used to provide an indication of identified risks and other information to an organization. In one embodiment, risk indications are stored to the content server 34 by the risk management module 42 for subsequent access by the risk management system 48 or organizations for which risks have been identified.

It is also contemplated that the transceiver 36 may enable communication through different networks or communication media. Where an organization implements the risk management system 48 within its own intranet or internal computer network, information collection may involve communication with external sources, whereas providing an indication of identified risks may involve internal transfer of information within the intranet, to a corporate file server for instance. In some embodiments, multiple transceivers 36 may be provided for communication with different information sources or in different communication networks.

The printer 47 represents an illustrative example of another type of device through which risk indications may be provided. Thus, in the system of FIG. 3, risk indications may be provided through one or more of the printer 47, the user interface 38, the memory 44, and the transceiver 36.

Reputation risk management as disclosed herein may be valuable, for instance, for large institutional investors that wish to assess previously hidden or unidentified reputation risks affecting current or contemplated holdings. Techniques according to embodiments of the invention may also be useful to regulators or audit committees of public companies and crown corporations as a component of overall corporate governance. A new executive or management team may also be provided with a better understanding of an organization through a detailed assessment of reputation risks as disclosed herein.

What has been described is merely illustrative of the application of principles of the invention. Other arrangements and methods can be implemented by those skilled in the art without departing from the scope of the present invention.

For example, an organization for which reputation risks are identified need not necessarily be a business. Although it is expected that businesses may gain significant benefits from effective risk management, non-profit entities and special interest groups may also benefit from reputation risk assessment and management.

Different functional responsibilities or divisions than those described above are also possible. In FIGS. 2 and 3 for instance, information collection and risk management functions have been separated solely for illustrative purposes. These functions may be performed by the same entity or functional component, as in the case of a processor-based implementation. Other divisions of an overall risk management scheme into more than two constituent functions or functional elements are also possible.

In addition, although described primarily in the context of methods and systems, other implementations of the invention are also contemplated, as instructions stored on a machine-readable medium for example.

We claim:

1. A risk management method comprising:
collecting, from at least one source external to an organization, information regarding implicit social contracts affecting the organization;
identifying a reputation risk to the organization based on the collected information; and
providing to the organization an indication of the identified reputation risk.

2. The method of claim 1, wherein collecting comprises collecting the information using at least one of: social survey, public document review, and retrieving previously collected information.

3. The method of claim 1, wherein collecting comprises collecting information from a plurality of sources.

4. The method of claim 1, wherein identifying comprises:
identifying as a risk any activity of the organization which may breach or fail to fulfil any of the implicit social contracts.

5. The method of claim 1, wherein providing comprises at least one of: printing an indication of the identified reputation risk, displaying an indication of the identified reputation risk, storing an indication of the identified reputation risk for subsequent retrieval, and transmitting to the organization an indication of the identified reputation risk.

6. The method of claim 1, wherein identifying comprises identifying a plurality of reputation risks, further comprising:
ranking the plurality of identified reputation risks according to at least one ranking priority criterion,
wherein providing comprises providing an indication of the plurality of reputation risks in order of ranking.

7. The method of claim 6, wherein the ranking priority criterion comprises at least one of: a frequency of occurrence criterion associated with a frequency of occurrence of each of the implicit social contracts in the collected information, a source rank criterion associated with rankings of the at least one source, and a source-assigned priority criterion associated with implicit social contract priorities assigned by the at least one source.

8. The method of claim 1, further comprising at least one of:
determining a valuation associated with the organization using the identified reputation risk;
determining and implementing a remedial action for the organization to mitigate the identified reputation risk;
collecting further information regarding risk factors affecting the organization from at least one internal source within the organization; and
determining and implementing a training program for the organization to disseminate the implicit social contracts, the identified reputation risk, or both.

9. The method of claim 1, further comprising:
collecting further information regarding risk factors affecting the organization from at least one internal source within the organization;
identifying at least one operational risk to the organization based on the collected further information; and
providing to the organization an indication of the identified operational risk.

10. The method of claim 1, further comprising at least one of:
collecting further information associated with activities of at least one other organization relating to the implicit social contracts or the identified risk and providing an indication thereof to the organization; and
collecting further information associated with legal proceedings relating to the implicit social contracts or the identified risk and providing an indication thereof to the organization.

11. The method of claim 1, further comprising, after providing the indication:
repeating the collecting;
determining a change in current collected information and previously collected information;
determining a risk vector for the reputation risk based on the determined change; and
providing to the organization an indication of the risk vector.

12. A machine-readable medium storing instructions which when executed perform the method of claim 1.

13. A risk management system comprising:
an information collection module for collecting, from at least one source external to an organization, information regarding implicit social contracts affecting the organization;
a risk management module coupled to receive the collected information from the information collection module and configured to identify a reputation risk to the organization based on the collected information; and
an output for providing to the organization an indication of the identified reputation risk.

14. The system of claim 13, wherein at least one of the information collection module and the risk management module is implemented in a processor.

15. The system of claim 13, wherein the information collection module collects information from at least one of: social survey, public documents, and previously collected information.

16. The system of claim 13, wherein the risk management module identifies the reputation risk by identifying as a risk any activity of the organization which may breach or fail to fulfil any of the implicit social contracts.

17. The system of claim 13, wherein the output is coupled to at least one of: a printer for printing an indication of the identified reputation risk, a display for displaying an indication of the identified reputation risk, a memory for storing an indication of the identified reputation risk for subsequent retrieval, and a transmitter for transmitting an indication of the identified reputation risk to the organization.

18. The system of claim 13, wherein the risk management module is configured to identify a plurality of reputation risks and to rank the plurality of identified reputation risks according to at least one ranking priority criterion, and wherein the output provides an indication of the plurality of reputation risks in order of ranking.

19. The system of claim 18, wherein the ranking priority criterion comprises at least one of: a frequency of occurrence criterion associated with a frequency of occurrence of each of the implicit social contracts in the collected information, a source rank criterion associated with rankings of the at least one source, and a source-assigned priority criterion associated with implicit social contract priorities assigned by the at least one source.

20. The system of claim 13, further comprising:
a valuation system for determining a valuation associated with the organization using the identified reputation risk.

21. The system of claim 13, wherein the risk management system further determines a remedial action for the organization to mitigate the identified reputation risk.

22. The system of claim 13, wherein the information collection module is configured to collect further information regarding risk factors affecting the organization from at least one internal source within the organization and to identify at least one operational risk to the organization based on the collected further information, and wherein the output provides an indication of the identified operational risk.

23. The system of claim 13, wherein the information collection module is configured to collect further information associated with activities of at least one other organization relating to the implicit social contracts or the identified risk, wherein the risk management module is further configured to determine a potential impact of the activities on the organization, and wherein the output provides an indication of the activities of the at least one other organization and the potential impact of the activities on the organization.

24. The system of claim 13, wherein the information collection module is configured to collect further information associated with legal proceedings relating to the implicit social trusts or the identified risk, wherein the risk management module is further configured to determine a potential impact of the legal proceedings on the organization, and wherein the output provides an indication of the legal proceedings and the potential impact of the legal proceedings on the organization.

25. The system of claim 13, wherein the information collection module is configured to collect information after the reputation risk has been identified, wherein the risk management module is further configured to determine a change in current collected information and previously collected information and a risk vector for the reputation risk based on the determined change, and wherein the output provides an indication of the risk vector.

26. The system of claim 13, wherein the information collection module is coupled to an interface for receiving the information from the at least one source.

27. The system of claim 13, further comprising at least one of:
a user interface for receiving the information as user inputs; and
a communication signal receiver for receiving the information in communication signals.

28. The system of claim 27, wherein the output is coupled to at least one of the user interface and a transmitter for transmitting communication signals to the organization.

29. A risk management method comprising:
collecting, from at least one source external to an organization, information regarding implicit social contracts affecting the organization;
identifying a reputation risk to the organization based on the collected information;
collecting further information associated with activities of at least one other organization relating to the implicit social contracts or the identified risk; and
providing to the organization an indication of the identified risk and the activities of the at least one other organization.

30. The method of claim 29, further comprising at least one of:
(a) determining a remedial action plan for the organization to mitigate the identified reputation risk, collecting further information regarding an impact of the remedial action plan on the implicit social contracts, and implementing the remedial action plan where the further information indicates a positive impact of the remedial action plan on the implicit social contracts;
(b) determining and implementing a training program for the organization to disseminate the implicit social contracts, the identified reputation risk, or both;
(c) collecting further information associated with legal proceedings relating to the implicit social contracts or the identified risk and providing an indication thereof to the organization; and
(d) determining a valuation associated with the identified reputation risk based on any of the further information.
